(19) United States
(12) Patent Application Publication
(10) Pub. No.: US 2011/0256998 A1
(43) Pub. Date: Oct. 20, 2011

(54) DEVICE AND METHOD FOR FORMING A FLEXIBLE TUBE FROM A MATERIAL WEB

(75) Inventor: Roland Tanner, Grut (CH)

(73) Assignee: FERAG AG, Hinwil (CH)

(21) Appl. No.: 13/128,663

(22) PCT Filed: May 28, 2009
(86) PCT No.: PCT/CH09/00180

§ 371 Date: May 27, 2011

(30) Foreign Application Priority Data
Nov. 13, 2008 (CH) 1770/08

(51) Int. Cl. B31C 1/00

(52) U.S. Cl. 493/269

(57) ABSTRACT

A device for forming a tube from a material web, in particular a film, which can be used for example for wrapping articles conveyed in a series one behind the other, and relates to a corresponding operating method. The device includes a bearing device for a roll of material web, a deflecting device for the material web and a drawing device, which is capable of moving the material web through the deflecting device. In the deflecting device, at least one first deflecting edge and one second deflecting edge are formed, wherein the first deflecting edge is shaped for deflecting the material web substantially transversely in relation to the longitudinal direction of the material web and wherein the at least one second deflecting edge is formed for folding the material web along at least one line running in the longitudinal direction.

### BACKGROUND OF THE INVENTION

1. Field of the Invention

The invention lies in the field of packaging technology and relates to a device for forming a flexible tube from a material web, in particular of a film, and to a corresponding operating method. The method and the device serve for example for packaging flat objects, for example of individual printed products and/or other products, e.g. CDs, flat sample objects or flat sample sachets, or for packaging stack-like groups of such objects.

2. Description of Related Art

It is known to package flat objects of the above mentioned type with the help of a quasi endless packaging material web, e.g. a plastic film or a paper web which is fed from the roll. Thereby, such a packaging material web is applied around the objects which are conveyed in a row one after the other and distanced to one another. Then, the packaging material web is closed in the longitudinal direction on the upper side of the row in longitudinal seams, and between in each case two consecutive objects in transverse seams. As the case may be, the objects which are enclosed on all sides by packaging material are also separated from one another after or during the creation of the transverse seams.

Devices for flexible tube formation are known for example from WP 2005/118400 or EP-B 1 319 595. They comprise in each case a storage device for a material web roll, a deflection device as well as a tension device, with which the material web may be wound from the material web roll in its longitudinal direction and pulled through the deflection device and thereby is deflected for the purpose of flexible tube formation. The deflection device comprises a first deflection edge, with which the material web is brought from an orientation of its web plane which as a rule is vertical or runs obliquely, into a position which as a rule is horizontal. Objects may be applied onto the horizontally orientated material web and, for this, a region of the material web which is not to be deflected and which serves as a rest for the objects, is usually supported from below. For wrapping (enveloping) the objects, the material web in a side region or at both side regions is turned over towards the web middle, i.e. the web is folded in the longitudinal direction. A second deflection edge serves for this, which is straight and runs obliquely to the longitudinal direction. If both side regions are to be turned over, then two deflection edges running to one another are present.

With the devices according to WO 2005/118400 or EP-B 1 319 595, the first deflection edge is formed in each case by a rod-like element (deflection rod) which is orientated essentially in a transverse direction of the web. The rod-like element in a plan view from above has a straight middle part with outer ends which are bent or curved in the movement direction of the web. This shape has the effect that the web which is led up from below and is deflected at the first deflection element, assumes the curvature of the first deflection element. The actual turning-over of the side regions at the second deflection edge is simplified by way of this and an overstretching of the material web is avoided with this turning-over.

The second deflection edge with the known devices is likewise realised by way of a rod-like element (deflection rod). In order for the film to run reliably over this deflection rod and for the web tension to be held constant, a row of pressing rollers, which press the material web against the defection rod, is arranged above this.

The following problems may occur with the known devices: The material web is compressed (squashed) at the bent section of the first deflection edge or is stretched in a non-uniform manner. One may not apply a uniform tensile stress over the whole film width. For this reason, a formation of creases or inhomogeneous stresses may occur in the material web, which, given a later welding, may lead to an unclean seam or to hole formation. Moreover, the material web part which is to be turned over is not supported in the region between the first deflection rod and the second deflection rod. The material web here may, thus, arch such that this may possibly not be able to be compensated by way of the subsequent pressing rollers, which may likewise compromise the later welding procedure. Finally, the use of a deflection rod with a circular cross section as a second deflection edge causes the pressing rollers to have only a point contact with the deflection rod, and thus several pressing rollers must be present in order to influence the material web in a defined manner.

Further devices for forming a flexible tube of web material are known from the documents EP-A 0 018 041, EP-A 1 652 771 and EP-A 1 500 591. With EP-A 0 018 041, the shape of the deflection elements is not explained in more detail. With EP-A 1 652 771 and EP-A 1 500 591, the film is shaped into a flexible tube via two-dimensional elements bent in a sleeve-like manner. A non-uniform build-up of the tensile stress and thus the formation of creases may likewise occur at the curved deflection edges.

A further need which has not yet been satisfactorily solved is the adaptability to different thicknesses and formats of the objects to be wrapped.

### BRIEF SUMMARY OF THE INVENTION

It is therefore the object of the invention to reduce the problems of the state of the art and in particular to provide a device for forming a flexible tube from a material web, in particular from a film, and a corresponding operating method, which permits a well defined guidance of the material web on turning over, so that the tensile stress which acts on the material web, is essentially constant over the complete web width.

The device for forming a flexible tube from a material web comprises a storage device for a material web roll, a deflection device for the material web and a tension device, with which the material web is moved in its longitudinal direction through the deflection device and is thereby deflected. The deflection device comprises a first deflection edge and at least one second deflection edge. The first deflection edge runs essentially transversely to the longitudinal direction of the material web and serves, for example, for bringing the material web from an initially vertical position into an essentially horizontal position. The at least one second deflection edge serves for turning over the material web along at least one line running in a longitudinal direction, thus for folding over one or both side regions towards the middle. For this, it is orientated at a first angle relative to the longitudinal direction and is arranged downstream from the first deflection edge. According to the invention, the first deflection edge has a first straight section as well as at least one second straight section, which enclose a second angle (β) to one another. In the case of application, the material web part which is not to be turned over runs over the first straight section, and the material web part or parts which is or are to be turned over, is or are led over the second straight section(s). If the flexible tube is formed by way of the material web being folded once, then the first deflection edge is therefore V-shaped in a plan view, and if the material web is turned over at the sides, it has three straight sections, wherein adjacent sections in each case enclose the angle β. The angle β is selected such that every point along any line running in the transverse direction covers essentially the same distance on running through the deflection device. This criterion of the path distance equality permits a constant web tension to be built up over the complete path width. It may only be achieved by a first deflection edge which is composed of straight sections. By way of this very simple measure, the invention permits a surprisingly good control of the web tension. A bending as with the state of the art however leads to different path lengths and thus to different tension or inhomogeneous stresses.

If further deflection edges are present, these are likewise preferably straight. Preferably, no arcuate or bend material bridges are located between the deflection edges, but the material web overcomes any distances without guidance. By way of this, one succeeds in every point on the material web being moved along a path which is straight or is composed of straight sections with an equal total length.

The invention is particularly well suited for a feed of the material web from below, i.e. so that it is deflected at the first deflection edge by approx. 90°.

The angle β in the normal case is an obtuse angle which lies close to 180°. Its magnitude is determined preferably in dependence on the first angle α. The smaller is α, the larger is β. Preferably, the following relation is essentially fulfilled:

β=2(90°−α).

The length of the first section of the deflection edge corresponds to the width of the material web path which is not to be turned over. The length of the second sections corresponds essential to the length of the material web parts which are to be turned over, but they may however be longer.

Preferably, the second deflection edge as well as the two sections of the first deflection edge or their imagined extension(s) in a plan view on the plane defined by the first deflection edge meet one another at one point.

The first deflection edge is preferably formed by the edge of a plane rest for the material web or its part which is not to be turned over and which in the entry region of the deflection device forms an edge with the described angularly bent shape. Alternatively, it may also be formed by a separate component, whose upper side lies in the plane of the rest surface. The first deflection edge may however also be defined by way of several separate elements. The rest may also be designed of several parts, e.g. from elements which mesh in one another in a comb-like manner or lie above one another in a staggered manner and whose distance is variable in the transverse direction, for the variation of the length of the first section. This serves for adapting the flexible tube width to different widths of the objects to be wrapped.

The second deflection edge is preferably formed by a plate-like deflection means. Its upper side forms a plane rest surface for the part of the material web which is to be turned over, said surface running parallel to the rest surface for the material web part which is not to be turned over. The already turned-over part runs parallel to the upper side on the lower side of the deflection means. A surfaced support and guidance of the material web is ensured by way of this, and an arching due to the airflow is, for example, prevented.

The plate-like deflection means may also form the second section of the first deflection edge. However, it is particularly preferable for its edge which faces the entry of the deflection device and which is adjacent the second deflection edge, to be arranged parallel or at a small angle of 5-20°, in particular 8° to the second section of the first deflection edge, but to have a distance thereto perpendicular to the plane of the rest. The flexible tube may be adapted to different heights of the objects to be wrapped by way of variation of this distance. The small angular difference has been found to be particularly advantageous in practice. Moreover, it is advantageous if the plate-like deflection means is arranged dropping slightly outwards, so that the clear height of the entry slot for the objects to be wrapped slightly reduces from the inside to the outside.

Preferably, two such plate-like deflection means are present for forming a material web which is turned over on two sides. The distance of the deflection means in the transverse direction is preferably variable for adaptation to the different widths of the objects to be wrapped.

Preferably, the material web within the deflection device is thus not only deflected at defined deflection edges with straight seconds, but by way of a suitable surfaced design of the deflection means and rests, it is also supported or guided in a surfaced manner at essentially every point in time. The position of the deflection edges is selected such that a tensile stress is produced, which is essentially constant over the whole width of the material web.

It is particularly advantageous if rollers are present for adapting the tensile force and/or tensile direction and which press the material web against the two-dimensional deflection means/rests. One or more such rollers may in particular be present above the plate-like deflection means in the direct vicinity of the second deflection edges. The axis of the rollers is preferably essentially perpendicular to the conveying direction of the material web, By way of this, one succeeds in the tensile stress being adapted such that the material web flexible tube is pulled together in the transverse direction and thus being applied tightly around the objects to be wrapped. The axis of the rollers may preferably be set in order to be able to carry to a fine adjustment of the tensile stress. The rollers may be driven or only co-moved by the material web.

The method according to the invention amid the use of the described flexible tube formation device, envisages the material web being deflected at the first deflection edge, wherein the part of the material web which is not to be turned over is led over the first section of the first deflection edge, and the part of the material web which is to be turned over is led over the second section of the first deflection edge, and further envisages turning over the part of the material web to be turned over, at the second deflection edge, in a manner such that a flexible tube is formed by material web parts which at least partly overlap one another. By way of a suitable choice of the position of the deflection edges, it is possible to build up a constant tensile stress over the complete web width and thus to avoid an undesirable crease formation. Irregularities in the created flexible tube are additionally avoided if the material web is supported or guided in a surfaced manner, in particular in the deflection device, in particular by way of suitably straight or plane rest surfaces. Preferably, the material web and the created flexible tube are themselves held under tension by way of the tension device, for example by way of a combination of rollers and/or conveyor belts as means which build up tension and which drive the web.

The deflection device may also be applied independently of the actual flexible tube formation device, i.e. without storage device and tension device, for example for the retrofitting of an existing flexible tube formation device.

### BRIEF DESCRIPTION OF THE DRAWINGS

Examples of the invention are represented in the drawings and are described hereinafter. In a purely schematic manner are shown in:

FIG. 1 a view of a flexible tube formation device for turning over the material web in both side regions;

FIG. 2 a view of the flexible tube formation device of FIG. 1 in the conveying direction of the material web on the rest surface of the flexible tube formation device;

FIG. 3 a view of the flexible tube formation device of FIG. 1 transverse to the conveying direction;

FIG. 4 a section through the two-dimensional deflection means which define a first and a further deflection edge;

FIG. 5 a plan view of the conveyor plane for the illustration of the angle between the deflection edges;

FIG. 6 a variant of the device of FIG. 1.

### DETAILED DESCRIPTION OF THE INVENTION

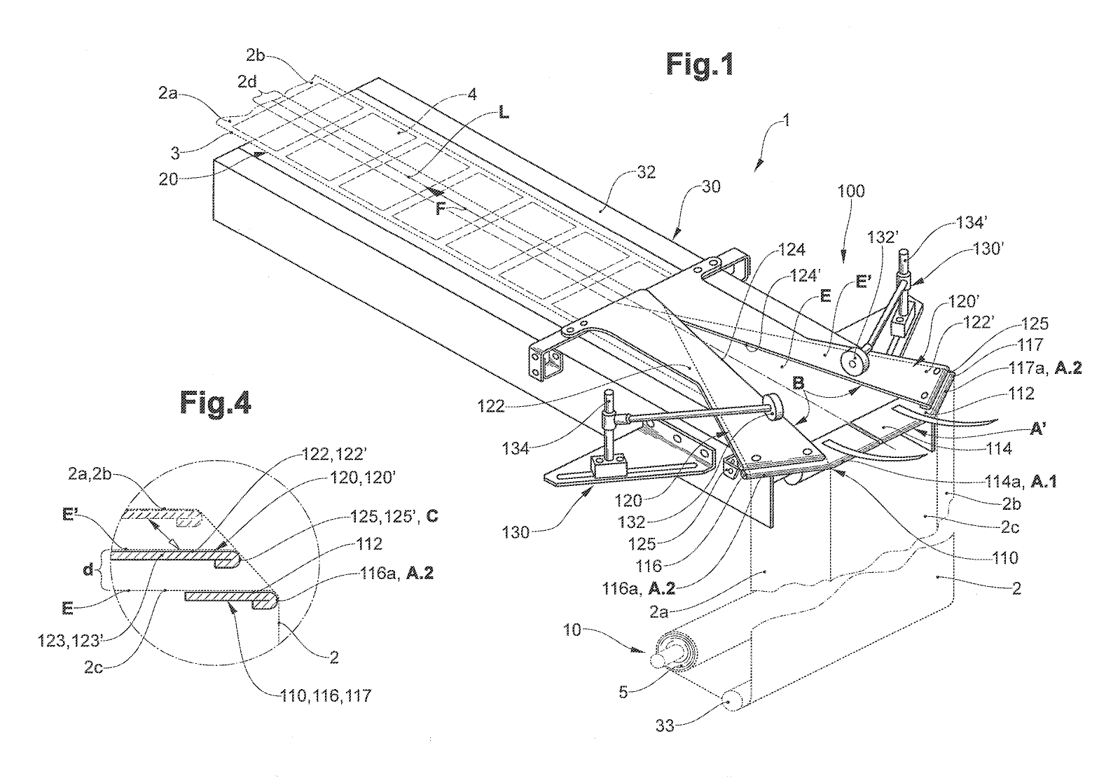

FIGS. 1-4 show a flexible tube formation device 1 which is designed for forming a flexible tube 3 of a continuous material web 2. The flexible tube 3 is produced by way of turning over two side regions 2a, 2b towards the middle region 2c, wherein the side regions 2a, 2b overlap in an overlapping region 2d and here may be connected to one another. It is schematically shown that the flexible tube 3 may be used for wrapping objects 4 which may be individual objects or stacks thereof and which are deposited one after the other in a row onto the middle region 2c.

The flexible tube formation device 1 comprises a storage device 10 for a material web roll 5, a tension device 20 and a deflection device 100 with which the firstly straight material web 2 is turned over into the flexible tube by way of it being pulled by the tension device 20 by the deflection device 100. It moreover comprises a support design 30 with a plane rest surface 32, on which the material web 2 or the flexible tube 3 lies, as the case may be, with the objects 4 to be wrapped. The rest surface 32 defines a conveying plane E. The longitudinal direction L is to be understood as the direction of the material web 2 or of the flexible tube 3 on lying on the rest surface 32. The material web 2 or the flexible tube 3 is moved in this direction (conveying device F). Before entry into the deflection device 100, the material web 2 may have other orientations and be additionally deflected by way of one or more deflection rollers 33 or other deflection means; here it is led up to the deflection device 100 in the vertical direction from below.

The tension device 20 here is formed by a belt conveyor with a conveyor belt 22 which is deflected about rollers 24 and whose upper section lies in the conveying plane E. The conveyor belt 22 runs essentially over the whole length of the support design 30. The drive may however also be realised in another manner e.g. by way of drive rollers arranged upstream of the deflection device 100. As the case may be, additionally further parts of the material web 2 and/or the storage device 10 may also be driven. Moreover, means for building up a constant web tension may be present, i.e. rolls or rollers which are pressed against one another.

A feed conveyor 40 is arranged upstream of the flexible tube formation device 1 (FIG. 3) and feeds the objects 4 to be wrapped in a row one after the other in the conveying plane E. Alternatively, the row of objects may also be produced directly on the material web 2. Examples of this are described in WO 2005/118400.

The flexible tube formation device 1 may, moreover, comprise welding devices which are not shown here, in order to close the flexible tube with a longitudinal seam and/or to form transverse seams in the flexible tube.

The deflection device 100 is described in more detail hereinafter:

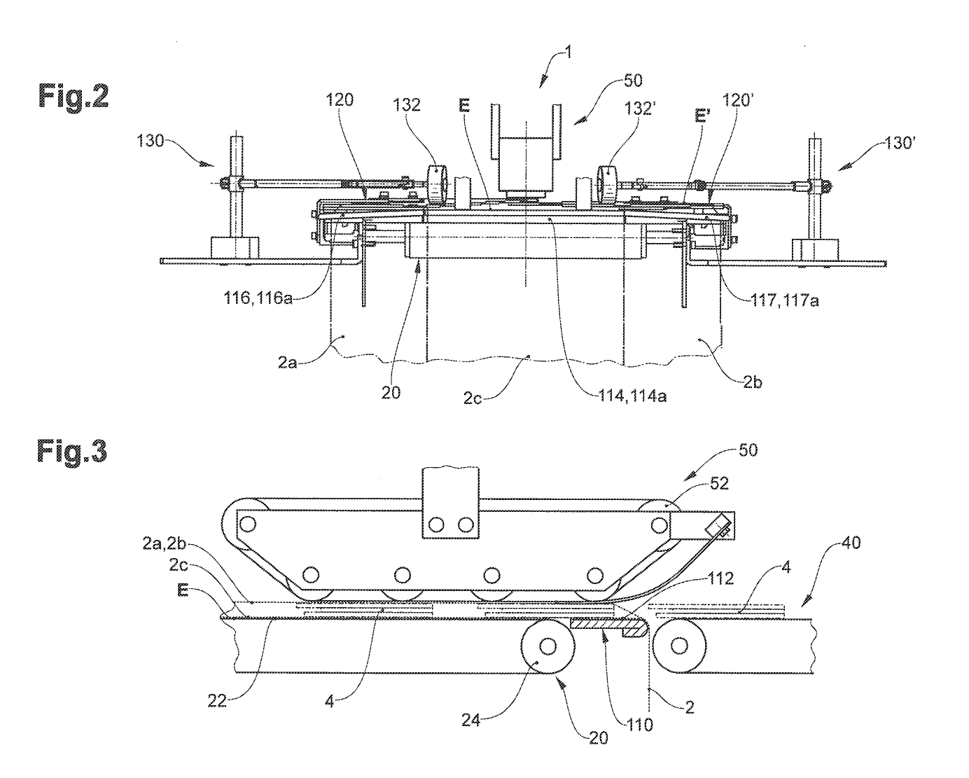

The deflection device 100 comprises a first plate-like deflection means 110 (first deflection unit) with a plane upper side 112 which is arranged essentially in the conveying plane E and is aligned to the rest surface 32 or to the conveyor belt 22 (FIG. 3) or alternatively may be an integral constituent of the rest surface 32. The first deflection unit 110 which may be formed in a single-piece or multi-piece manner, comprises a middle part 114 which is rectangular in the plan view, as well as two side parts 116, 117 which are arranged laterally thereto. The edges 114a, 116a, 117a of these three elements and which are orientated upstream, together form the first deflection edge A for the material web 2 as well as the entry of the deflection device 100. As shown in FIG. 2, the upper side of the middle part 14 lies in the conveying plane E, whilst the upper sides of the side parts 116, 117 drop slightly outwards. The middle part 114 may also be designed of two parts, wherein the two parts may be displaceable to one another transverse to the conveying direction for adaptation of the length of the edge 114a to the desired flexible tube width.

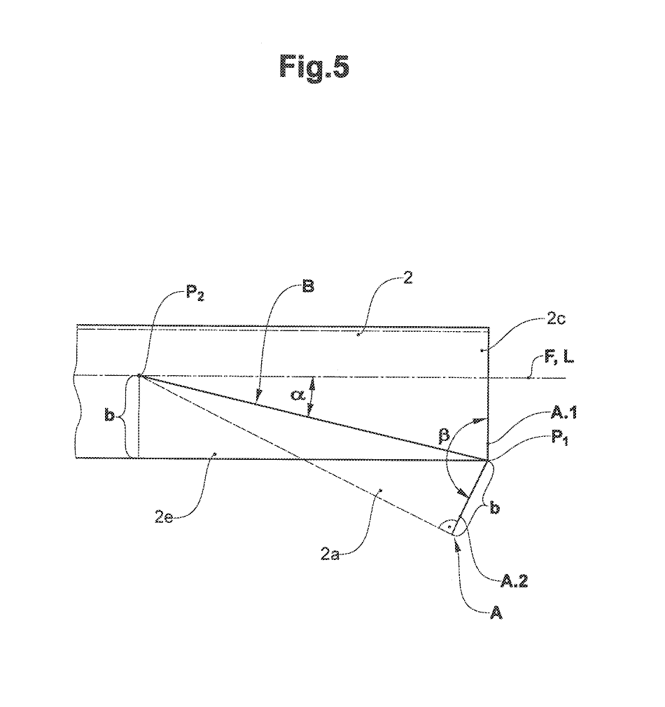

The first deflection edge A may thus be subdivided into three straight sections: A first section A.1, which is formed by the edge 114a and which is directed transversely to the longitudinal direction L or the conveying direction F, as well as two second sections A.2 which in each case enclose an acute angle β with the section A.1 (see FIG. 5 for the angle definition). Accordingly, only one a second section A.2 may be present, in the case that only one side region 2a, 2b is to be turned over.

The deflection device 100 moreover comprises two second, plate-like deflection means 120, 120′ (second deflection units) which are distanced to the conveying plane E. The distance d between the plane upper sides 122, 122′ of the deflection means 120, 120′ and the conveying plane E, may be varied as is shown in FIG. 4. The deflection means 120, 120′ moreover have a plane lower side 123, 123′ which runs parallel to the upper side.

The second deflection units 120, 120′ in a plan view from above have an essentially trapezoidal shape which may be selected freely within certain limits. They are designed mirror-symmetrically to one another with regard to the middle axis of the material web 2. The following two side edges of the deflection units 120, 120′ are of significance: the edges 124, 124′ which are orientated at a small angle α obliquely to the longitudinal direction and which face the middle of the material web; and the edges 125, 125′ which face the entry of the deflection device 100 and which run parallel to the second sections A.2. The edges 124, 124′ act as second deflection edges B, around which the material web parts 2a, 2b to be turned over run. The edges 125, 125′ act as further deflection edges C, whose function is described further below.

The upper sides 122, 122′ of the second plate-like deflection means 120, 120′ serve as rest surfaces for the parts 2a, 2b of the material web 2 which are yet to be turned over, and the lower sides 123, 123′ as guide surfaces for these material web parts after the turning-over.

The second plate-like deflection means 120, 120′ are mounted such that their distance in the transverse direction to the material web 2 may be changed. In the region which is away from the entry of the deflection device 100, the deflection means 120, 120′ overlap and are therefore located at slightly different heights above the conveying plane E (see FIG. 2).

The plate-like deflection means 110, 120, 120′ may be formed by one or more sheet-metal parts. Preferably, as is shown in FIG. 4 for some of the edges, they are bent over downwards for forming rounded edges 114a, 116a, 117a, 125, 125′, so that damage to the material web 2 is avoided.

The deflection device 100 moreover comprises two devices for varying the flexible tube tension 130, 130′, which in each case are assigned to one of the second deflection means 120, 120′. They comprise in each case a roller 132, 132′, which is mounted on a mounting 134, 134′ (column with a lever which is arranged thereon in a pivotable and height-adjustable manner) in a projecting manner and in a manner such that its position as well as its orientation relative to the deflection means 120, 120′ and the height above the conveying plane E may be set. Here, the rotation axes of the rollers 132, 132′ have an orientation running essentially perpendicularly to the edges 124, 124′. The device for varying the flexible tube tension 130, 130′ serves for preventing a lifting of the material web 2 from the underlay 122, 122′ as well as for a fine correction in the tensile stress or the tensile direction. Since the rollers 132, 132′ make a linear or surfaced contact with the flat upper side 122, 122′ of the deflection means 120, 120, the direction correction, in contrast to the state of the art, may be achieved in each case by only a single element, and the use of several rollers is possible however.

As FIGS. 2 and 3 show, a pressing device 50 with further conveyor belt 52 which is orientated parallel to but running counter to the conveyor belt 22, is located in the entry region of the flexible tube formation device 1, above the conveyor belt 22. The pressing device 50 serves for holding together the objects 4 coming from the feed device 40, in a direction perpendicular to the conveying plane E, so that the individual constituents, with a more complex formation, in particular stacks of individual objects, do not dislocate from one another before the flexible tube formation.

FIG. 5 illustrates the geometric conditions with the deflection of a material web section 2a of the width b at the first and second deflection edge A, B in a plan view on the conveying plane E. For reasons of a better overview, only the deflection in a side region 2a is shown. The first deflection edge A comprises a first section A.1, whose width corresponds to the middle web part 2c which is not to be deflected and which is arranged perpendicularly to the conveying direction or longitudinal direction F, L. A second section A.2 is arranged at an angle to the conveying direction F such that it encloses an angle β with the section A.1. The second deflection edge B runs at an angle α obliquely to the conveying direction F. The edges A.1, A.2 and B meet one another at a point P1 in a plan view. The material web part 2a is completely turned over at a further point P2, i.e. its distance to the fold line 2e between the material web parts 2a and 2c corresponds to the width b of the material web part 2a.

The material web 2 is fed from a direction perpendicular to the plane of the drawing (conveying plane E). This means that all points along an imagined line running in the transverse direction, until meeting the first deflection edge, have covered the same distance. The path lengths within the deflection device, i.e. at least until exceeding the transverse line running through P2, must be equal for all points lying next to one another, so that no inhomogeneous stresses are built up within the deflection device. This may only be fulfilled when the first deflection edge A consists of straight sections A.1, A.2. In this example β=2(90°−α) for the angle α, β is the case. In the case that the web is fed from a direction other than the perpendicular one, additional path differences until meeting the first deflection edge A are introduced by way of this, which may be compensated by way of adaptation of the angle β.

In the case that the width b of the material web part 2a to be turned over, is to be changed, it is advantageous to also adapt the angles α, β. This is preferably advantageously realised by way of the second plate-like deflection means 120, 120′ and the lateral wings 116, 117 being pivotable about an axis perpendicular to the conveying plane E.

In principle, the second plate-like deflection means 120, 120′ may lie in or slightly above the conveying plane E, wherein the deflection means 120, 120′ may also form the second sections A.2 of the first defection edge A. In this case, one may make do without separate side parts 116, 117. For wrapping objects 4 which have a certain height, it is however advantageous if the upper sides 122, 122′ of the deflection means 120, 120′ lie at a distance d to the conveying plane E in a further plane E′, which is somewhat larger than the object height. The lateral material web parts 2a, 2b may, thus, be reliably applied around the objects. As is shown in FIG. 4, the material web 2 in the region 2a, 2b to be folded over is therefore deflected obliquely (about approx.) 45°) over the first deflection edge A (section A.2) and then runs over the side edge 125, 125′ of the deflection means 120, 120′ which is orientated parallel to A.2 and which thus acts as a further deflection edge C and determines the flexible tubing height. Here the material web parts 2a, 2b are deflected into the horizontal. The deflection means 120, 120′ is thereby additionally displaced parallel in the conveying direction, so that the deflection angle at the edge A.2 is essentially maintained, so that a change in the distance d does not lead to inhomogeneous stresses.

The deflection means 110, 120, 120′ with a continuous rest surface have the advantage that the material web 2 is led in a surfaced manner after a deflection at the edges, and arching and crease formation is prevented. In principle however, it is possible to realise the deflection edges A, B and, as the case may be, C by way of individual or coherent linear elements, e.g. rods, and to leave the material web unguided in the space therebetween. A continuous rest surface is also to be understood as a non-continuous surface, e.g. a perforated plate or likewise.

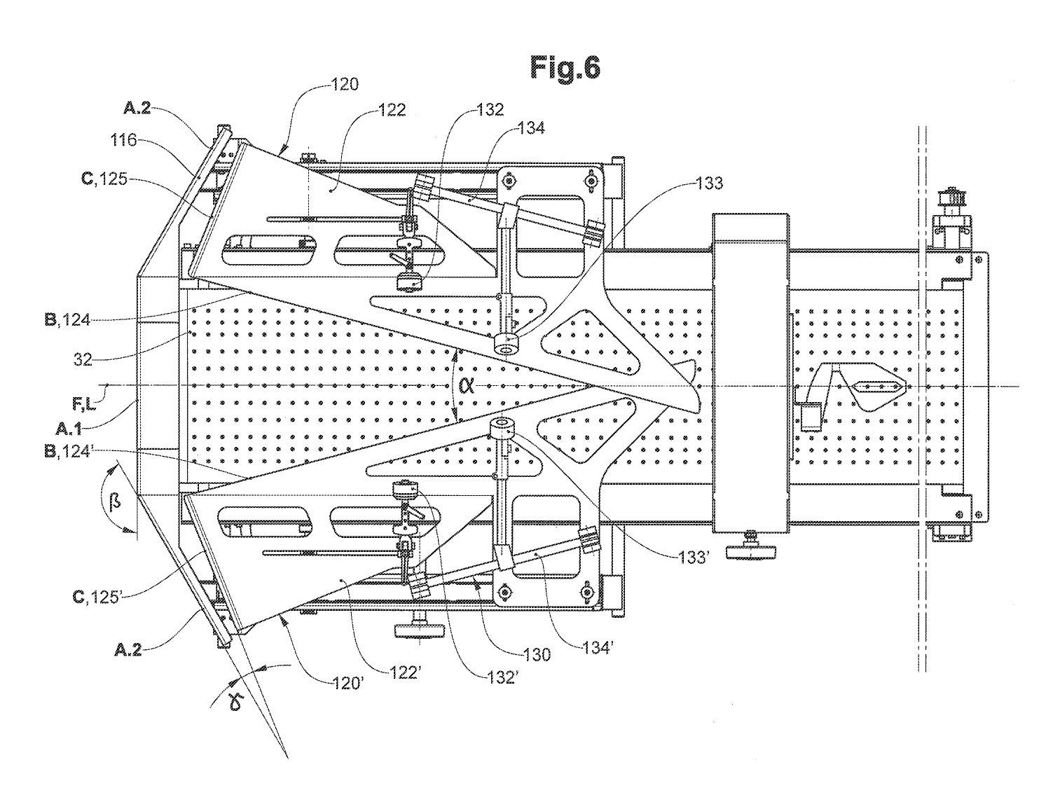

FIG. 6 shows a variant of the device of FIG. 1. The same parts are provided with the same reference numerals. Hereinafter, only the differences are dealt with:

In contrast to FIG. 1, the second sections A.2 of the first deflection edge A do not run parallel to the third deflection edges C which are formed by the plate-like deflection means 120, 120′. A small angle γ of 5-12,° here 8° is enclosed. As the present plan view representation shows, the edges A.2 and C are also not arranged in a common vertical plane, i.e. flush with one another in a plan view, but have a distance to one another seen in the horizontal direction. Path differences of (imagined) points, which are arranged along a transverse line of the material web, are compensated by the angle γ with a passage through the flexible tube formation device. The flexible tube formation device is particularly adapted, so that the material web may be fed to it essentially perpendicularly from below and thus at approx. 90° to the first deflection edge A.

A further difference lies in the design of the device for varying the flexible tube tension 130, 130′. This here comprises, in each case, two rollers 132, 133 and 132′, 133′ respectively. Their position above the plate-like deflection means 120, 120′ and the orientation of the rotation axes may be individually adapted. Here, the rollers 133, 133′ lying downstream are pivoted into an inactive opposition. The rotation axes of the other rollers 132, 132′ run perpendicularly to the conveying direction or to the longitudinal direction F, L. Since the rollers 132, 132′ act on the material web in the region, in which the material web is deflected about the second edges B, the material web is pulled slightly together in the transverse direction and is applied tightly around the objects to be wrapped. The devices here, thus, primarily serve for setting or varying the transverse stress of the material web.

It is not evident in the present representation that the plate-like deflection means 120, 120′ preferably do not run exactly parallel to the lower rest surface 32, but drop outwards slightly with an inclination of a few degrees.

1.-20. (canceled)

21. A device for forming a flexible tube from a material web, in particular from a film, comprising:
a storage device for a material web roll;
a deflection device for the material web; and
a tension device which is capable of moving the material web through the deflection device,
wherein the deflection device comprises a first deflection edge and at least one second deflection edge, wherein the first deflection edge for deflecting the material web runs essentially transversely to the longitudinal direction of the material web, and wherein the at least one second deflection edge is designed for turning over the material web along at least one line running in the longitudinal direction, by way of it being orientated at a first angle relative to the longitudinal direction and being arranged downstream of the first deflection edge;
wherein the first deflection edge comprises a first straight section as well as at least one second straight section, which enclose a second angle with one another.

22. A device according to claim 21, wherein the second angle is adapted to the first angle in a manner such that the material web may be turned over along the second deflection edge essentially without compressing.

23. A device according to claim 22, wherein the following relation is essentially fulfilled: β=2(90°−α), wherein α denotes the first angle and β denotes the second angle.

24. A device according to claim 21, wherein the deflection device defines at least one further deflection edge which is arranged at a distance parallel, or at a small angle, to the second section of the first deflection edge, and wherein the distance between the second section of the first deflection edge and the further deflection edge is variable.

25. A device according to one claim 21, further comprising at least one plane first rest surface for the part of the material web which is not to be turned over, and at least one plate-like deflection means which is distanced thereto and which has a plane, second rest surface for the part of the material web to be turned over, said second rest surface running parallel to the first rest surface.

26. A device according to claim 25, wherein the first section of the first deflection edge is formed by way of the side edge of the rest surface which is orientated upstream, wherein one of the side edges of the second rest surface forms the second deflection edge, and wherein a side edge of the second rest surface which is adjacent thereto, forms the second section of the first deflection edge or runs parallel thereto.

27. A device according to claim 25, wherein two plate-like deflection means are present, which with respect to the longitudinal direction of the material web are arranged mirror-symmetrically to one another in a manner such that the second deflection edges seen in the conveying direction run to one another and intersect one another, and wherein the distance of the deflection means in the transverse direction of the material web is variable in the transverse direction of the material web for setting the width of the flexible tube.

28. A device according to claim 25, wherein the distance of the at least one deflection means to the first rest surface is variable.

29. A device according to claim 25, further comprising at least one device for varying the flexible tube tension, which is capable of pressing the material web in the part to be turned over, against the second rest surface.

30. A device according to claim 29, wherein the device for varying the flexible tube tension comprises at least one roller which is mounted in a manner such that the orientation of its rotation axis and its position is variable.

31. A device according to claim 21, wherein the first deflection edge is arranged in an essentially horizontal first plane and that the second deflection edge or the second deflection edges is or are arranged in an essentially horizontal second plane lying thereabove, wherein the part of the material web which is not to be turned over is deflected by the first section of the first deflection edge into the first plane, and the part of the material web which is to be turned over is deflected by the at least one second deflection edge into the second plane or a further plane running between the second and the first plane.

32. A device according to claim 21, further comprising at least one welding device for welding the material web turned over into a flexible tube, in the longitudinal direction and/or transverse direction.

33. A device according to claim 21, further comprising a feed device for objects, which is capable of depositing the objects onto the part of the material web which is not to be turned over.

34. A method for forming a flexible tube from a material web, in particular from a film, with a device according to claim 21, comprising the following steps
deflecting the material web at the first deflection edge, wherein the part of the material web, which is not to be turned over, is guided over the first section of the first deflection edge, and the part of the material web which is to be turned over is guided over the second section of the first deflection edge;
further deflecting the part of the material web which is to be turned over, at the second deflection edge, in a manner such that a flexible tube is formed from material web parts which at least partly overlap one another.

35. A method according to claim 34, further comprising supporting or guiding the material web, on running through the deflection device, in a two-dimensional manner.

36. A method according to claim 34, further comprising selecting the position of the deflection edges such that a tensile stress is produced, which is essentially constant over the whole width of the material web.

37. A method according to claim 34, further comprising varying the tensile stress and/or tensile direction by at least one device for varying the flexible tube tension, which cooperates with a two-dimensional counter-element.

38. A method according to claim 34, further comprising adapting the position and/or distances of the second deflection edges for setting the flexible tube width.

39. A method according to claim 34, further comprising adapting the distances of the plane of the first deflection edge and of the second deflection edge for setting the flexible tube height, for the purpose of adapting to different heights of objects to be wrapped by the flexible tube.

40. A method according to claim 34, further comprising welding the material web which is turned over into a flexible tube, in the longitudinal and/or transverse direction.

41. A deflection device for a device for forming a flexible tube from a material web, in particular from a film, wherein the deflection device comprises:
a first deflection edge and
at least one second deflection edge,
wherein the first deflection edge for deflecting the material web runs essentially transversely to the longitudinal direction of the material web, and
wherein the at least one second deflection edge is designed for turning over the material web along at least one line running in the longitudinal direction of the material web, by way of it being orientated at a first angle relative to the longitudinal direction and arranged downstream of the first deflection edge, wherein the first deflection edge comprises a first straight section as well as at least one second straight section, which enclose a second angle with one another.
